(19) United States
(12) Patent Application Publication
(10) Pub. No.: US 2023/0367556 A1
(43) Pub. Date: Nov. 16, 2023

(54) Code Editing Tracking and Management for Vision Impaired

(71) Applicant: Microsoft Technology Licensing, LLC, Redmond, WA (US)

(72) Inventors: Vesa Pekka RAUTIAINEN, Pyhätunturi (FI); Miguel SOLORIO, Duvall, WA (US); Taysser GHERFAL, Redmond, WA (US)

(21) Appl. No.: 17/745,649

(22) Filed: May 16, 2022

(51) Int. Cl. G06F 8/33; G06F 8/71

(52) U.S. Cl. CPC G06F 8/33; G06F 8/71

(57) ABSTRACT

A computer implemented method includes receiving changes to respective lines of code of multiple numbered lines of code displayed by a code editing program, the changes including a deletion type change, an addition type change, and a modification type change, and for each change. The type of change is detected for each received change. Display of an addition graphic is caused in response to the type of change being an addition to the line of code. Display of a modification graphic having discernable markings within a boundary of the modification graphic is caused in response to the type of change being a modification to the line of code. Display of a deletion graphic is caused in response to the type of change being a deletion of the line of code.

### BACKGROUND

When a code developer makes changes to a code file displayed in an editor window, the changed lines may be indicated on a left side of an editor window. Change are generally one of these types: Deletion, Addition, or Modification. Different shapes or patterns may be used as indications associated with lines of code to identify the type of change. Different colors may also be used.

Changed lines can be either saved to source control area, or unsaved. The saved and unsaved states may also have their own distinguished styles. The change indicators may also be interactive such that when hovered over, they grow and a tooltip may be shown. The indicators grow to indicate that they can be clicked. Clicking on the indicator opens a window that illustrates the change.

### SUMMARY

A computer implemented method includes receiving changes to respective lines of code of multiple numbered lines of code displayed by a code editing program, the changes including a deletion type change, an addition type change, and a modification type change, and for each change. The type of change is detected for each received change. Display of an addition graphic is caused in response to the type of change being an addition to the line of code. Display of a modification graphic having discernable markings within a boundary of the modification graphic is caused in response to the type of change being a modification to the line of code. Display of a deletion graphic is caused in response to the type of change being a deletion of the line of code.

### BRIEF DESCRIPTION OF THE DRAWINGS

FIG. 1 is a block diagram of a system for editing code and providing graphical indicators (graphics) of multiple different code change states in a code listing according to an example embodiment.

FIG. 2 is chart illustrating example graphics at for representing multiple different states of code changes according to an example embodiment.

FIG. 3 is a code listing shown in a light/blue theme utilizing the graphics to identify changes in lines of code according to an example embodiment.

FIG. 4 is a code listing shown in a dark theme utilizing the graphics to identify changes in lines of code according to an example embodiment.

FIG. 5 is a flowchart of a computer implemented method of using different graphic indicators for representing changes to code according to an example embodiment.

FIG. 6 is a chart illustrating example graphic indicators having different colors for a blue theme display in addition to the use of a pattern in the modification graphic to help discernably distinguish different types of changes to code according to an example embodiment.

FIGS. 7A, 7B, 7C, 7D, 7E, and 7F are screen shots indicating cursors hovering over or near selected change graphics with a tip shown to indicate the type of change as well as a state of the change corresponding to whether the change has been saved or not saved according to an example embodiment.

FIG. 8 illustrates alternative change graphics according to an example embodiment.

FIG. 9 illustrates alternative change graphics according to an example embodiment.

FIG. 10 illustrates alternative modification graphics according to an example embodiment.

FIG. 11 illustrates alternative change graphics according to an example embodiment.

FIG. 12 is a block schematic diagram of a computer system to implement one or more example embodiments.

### DETAILED DESCRIPTION

In the following description, reference is made to the accompanying drawings that form a part hereof, and in which is shown by way of illustration specific embodiments which may be practiced. These embodiments are described in sufficient detail to enable those skilled in the art to practice the invention. and it is to be understood that other embodiments may be utilized and that structural, logical and electrical changes may be made without departing from the scope of the present invention. The following description of example embodiments is, therefore, not to be taken in a limited sense, and the scope of the present invention is defined by the appended claims.

The functions or algorithms described herein may be implemented in software in one embodiment. The software may consist of computer executable instructions stored on computer readable media or computer readable storage device such as one or more non-transitory memories or other type of hardware-based storage devices, either local or networked. Further, such functions correspond to modules, which may be software, hardware, firmware or any combination thereof. Multiple functions may be performed in one or more modules as desired, and the embodiments described are merely examples. The software may be executed on a digital signal processor, ASIC, microprocessor, or other type of processor operating on a computer system, such as a personal computer, server or other computer system, turning such computer system into a specifically programmed machine.

The functionality can be configured to perform an operation using, for instance, software, hardware, firmware, or the like. For example, the phrase “configured to” can refer to a logic circuit structure of a hardware element that is to implement the associated functionality. The phrase “configured to” can also refer to a logic circuit structure of a hardware element that is to implement the coding design of associated functionality of firmware or software. The term “module” refers to a structural element that can be implemented using any suitable hardware (e.g., a processor, among others), software (e.g., an application, among others), firmware, or any combination of hardware, software, and firmware. The term, “logic” encompasses any functionality for performing a task, For instance, each operation illustrated in the flowcharts corresponds to logic for performing that operation. An operation can be performed using, software, hardware, firmware, or the like. The terms, “component,” “system,” and the like may refer to computer-related entities, hardware, and software in execution, firmware, or combination thereof. A component may be a process running on a processor, an object, an executable, a program, a function, a subroutine, a computer, or a combination of software and hardware. The term, “processor,” may refer to a hardware component, such as a processing unit of a computer system.

Furthermore, the claimed subject matter may be implemented as a method, apparatus, or article of manufacture using standard programming and engineering techniques to produce software, firmware, hardware, or any combination thereof to control a computing device to implement the disclosed subject matter. The term, “article of manufacture,” as used herein is intended to encompass a computer program accessible from any computer-readable storage device or media. Computer-readable storage media can include, but are not limited to, magnetic storage devices, e.g., hard disk, floppy disk, magnetic strips, optical disk, compact disk (CD), digital versatile disk (DVD), smart cards, flash memory devices, among others. In contrast, computer-readable media, i.e., not storage media, may additionally include communication media such as transmission media for wireless signals and the like.

When modifying code, editors can provide indications in a code listing identifying what lines of code have been changed. A color attribute is commonly used along with various shapes to identify different types of changes, such as deleted, added, or modified, or even whether or not changes have been saved to a code repository. When combining all the types of changes and saved status there are total twelve different states to uniquely identify. To be fully accessible to people who have difficulty distinguishing various colors, each of these states should be easily distinguishable from each other without relying on the color attribute alone.

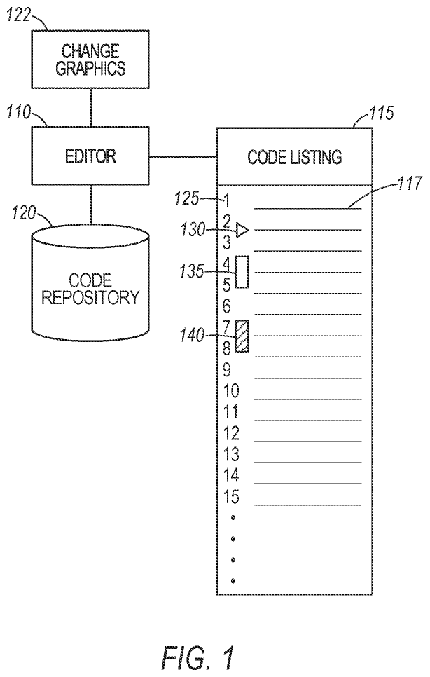

FIG. 1 is a block diagram of a system 100 for editing code and providing graphical indicators (graphics) of multiple different code change states in a code listing, System 100 includes a code editor 110 for enabling users to modify computer code. An example code listing 115 shows multiple lines of numbered code. Lines 117 of code are shown in the listing 115 with a light/blue display theme. The listing 115 may have been previously written and stored in a code repository 120. The listing 115 has been accessed from the code repository 120 by the editor 110 and has also been changed as shown.

In response to receiving changes, the editor 110 determines the type of change, such as deletion of a line, adding a line, and modification of a line. The editor 110 accesses a corresponding change graphic from a change graphics memory 122.

Three change graphics are illustrated in a margin or gutter next to the line numbers 125. A deletion graphic 130 is shown between lines numbers 2 and 3, indicating that a previous line 3 was deleted. The deletion graphic 130 is a triangle in one example, as has already been commonly used. In one example, the deletion graphic 130 is an outline of a triangle.

An addition graphic 135 indicates that lines 4 and 5 have been added to the code listing 115. The addition graphic 135 is a rectangle having a contiguous length extending along both of lines 4 and 5. If only one line had been added, the addition graphic 135 would only extend along one of the lines. The addition graphic 135 may extend along even more lines in further examples and is shown as an outline of a rectangle.

A modification graphic 140 indicates that lines 7 and 8 have been modified in the code listing 115. The modification graphic 140 is a rectangle having a contiguous length extending along both of lines 7 and 8. If only one line had been modified, the modification graphic 140 would only extend along one of the lines. The modification graphic may extend along even more lines in further examples and is shown as an outline of a rectangle, which may have the same outline as the addition graphic 135.

The modification graphic has discernable markings inside the outline to distinguish it visually from the addition graphic 135. In one example, the discernable markings are a pattern such as discernable lines. The discernable lines in one example are a diagonal hash pattern as shown. The discernable markings may be in the form of continuable repeatable patterns. In other words, each modification graphic for each consecutively modified line of code matches up with adjacent modification graphics such that the pattern is continuous, making the adjacent modification graphics appear as a single continuous modification graphic.

The graphics are sized to fit unobtrusively between the line numbers 125 and the actual code 117 in a spot commonly referred to as the gutter of the code listing 115.

The graphics 130, 135 and 140 represent changes made to code that has not yet been saved back to the code repository 120. Upon saving the code, fill is used for each of the graphics to indicate that the code has been saved. The fill may take different forms for the different graphics as shown in further detail below with respect to both light and dark display themes. In further examples, color may also be used for different aspects of the graphics in order to accentuate the different representation of state of change for those who can distinguish colors. In one example red may be used for the deletion graphic 130, green for the addition graphic 135, and blue for the modification graphic 140.

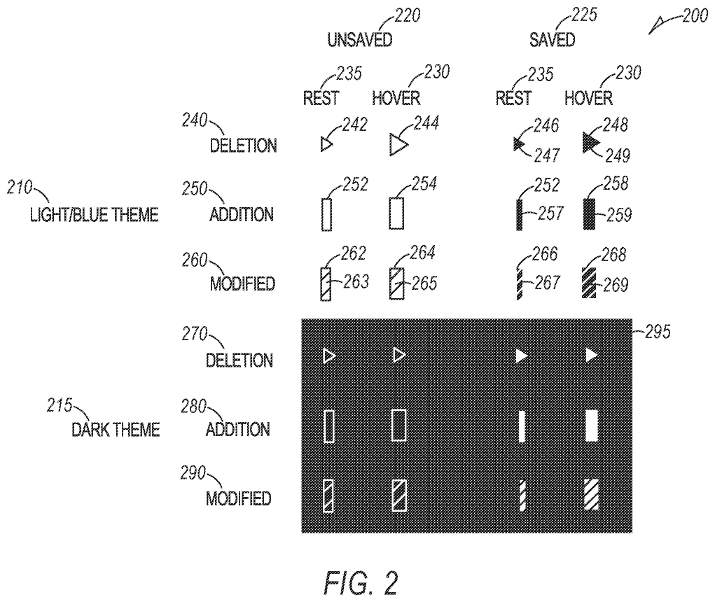

FIG. 2 is chart illustrating example graphics at 200 for representing multiple different states of code changes. Graphics for both a light/blue display theme 210 and a dark theme 215 are shown for both unsaved 220 and saved 225 states. Still further enlarged graphics are also indicated for states where the cursor is hovering 230 over a graphic, or not hovering over a graphic, referred to as a rest state 235. A first row shows multiple graphics for both the rest and hover states for deletion 240. A delete graphic 242 in the light/blue theme 210 is unsaved and at rest, meaning the cursor is not hovering over the graphic. Delete graphic 242 is an outline of a triangle and is unfilled. Delete graphic 244 is an enlarged version of delete graphic 242. In one example, the enlargement of the deletion graphic may be about twice the size of the at rest deletion graphic, or some other noticeable change in size. Saved versions of the same two delete graphics are shown at 246 and 248 respectively. Delete graphics 246 and 248 the same shape, with respective fill 247 and 249. The fill may be the same color and shade as the outline of the triangle. The fill enables a viewer to easily discern the differences between saved and unsaved versions of the graphics.

A second row shows multiple graphics for both the rest and hover states for addition 250. An addition graphic 252 in the light/blue theme 210 is unsaved and at rest, meaning the cursor is not hovering over the graphic. Addition graphic 252 is an outline of a rectangle and is unfilled. Addition graphic 254 is an enlarged version of addition graphic 252. In one example, the enlargement of graphics may be about twice the width of the at rest addition graphic 252, or some other noticeable change in size. Saved versions of the same two addition graphics are shown at 256 and 258 respectively. Addition graphics 256 and 258 have the same shape, with respective fill 257 and 259. The fill may be the same color and shade as the outline of the triangle. The fill enables a viewer to easily discern the differences between saved and unsaved versions of the graphics.

If two or more consecutive lines of code are added, their corresponding change graphics are aligned to form a single rectangle outline spanning all the changed lines. The portions where such change graphics are aligned have the corresponding outlines removed to form the single rectangle outline. Such an addition graphic for multiple consecutive lines of code is shown in further figures.

A third row shows multiple graphics for both the rest and hover states for modifications 260. A modification graphic 262. in the light/blue theme 210 is unsaved and at rest, meaning the cursor is not hovering over the graphic. Modification graphic 262 is an outline of a rectangle, is unfilled, and also includes discernable fill comprising markings or a pattern. In one example the fill is in the form of discernable lines 263. The lines 263 may be horizontal, vertical, or slanted as shown. The lines 263 may have the same or similar thickness as the outline for the modification graphic 262.

Modification graphic 264 is an enlarged version of modification graphic 262, with lines 265, also enlarged. In one example, the enlargement of graphics may be about twice the width of the at rest modification graphic 262, or some other noticeable change in size. Saved versions of the same two modification graphics are shown at saved modification graphic 266 with lines 267 and saved modification graphic 268 with lines 269. Modification graphics 266 and 268 have the same shape, with respective fill lines 267 and 269. The fill may be the same color and shade as the outline of rectangle. In one example, the outline of the rectangle is removed from the rectangle. Even without the outline of the rectangle, the wider fill lines give the perception of a rectangle having a boundary, while providing a further easily discernable difference from the unsaved versions of the modification graphics. The fill enables a viewer to easily discern the differences between saved and unsaved versions of the graphics.

In one example, the fill pattern is designed such that when two or more lines of code are modified, the corresponding modification graphics are aligned end to end with the outline where the patterns meet being removed. The resulting aligned modification graphics appear as a single rectangular outline with a continuable repeatable pattern as fill. Such a modification graphic for multiple consecutive lines of code is shown in further figures.

Graphics for the dark theme 215 are shown in deletion row 270, addition row 280, and modification row 290. The dark theme with corresponding graphics is shown at 295. Note that the outlines and the fill pattern are light color, with the insides of the outlines and the fill pattern containing the same background as the dark theme 215.

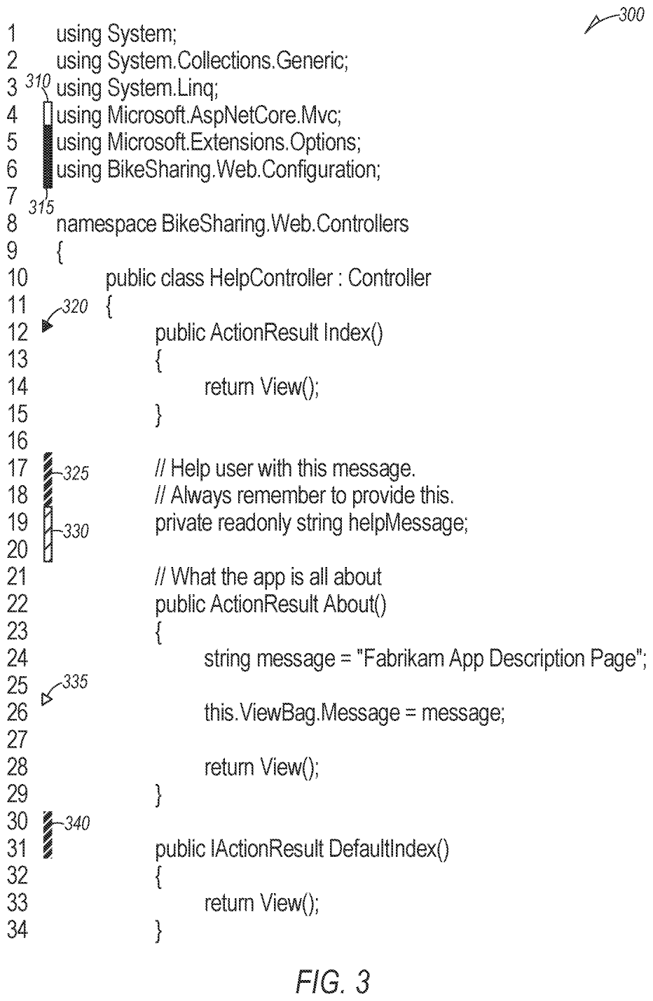

FIG. 3 is a code listing 300 shown in a light/blue theme utilizing the graphics 200 to identify changes in lines of code. The lines of code are numbered in a column 305 corresponding to the left margin or gutter of the code listing. An addition graphic 310 is shown next to line 4 of the code to indicate that line 4 has been added, but has not been saved, as addition graphic 310 does not contain fill. Addition graphic 315 has fill, indicating that lines 5 and 6 have been added and saved. Deletion graphic 320 indicates that a line or lines between current lines 11 and 12 has been deleted and saved.

Modification graphic 325 indicates that lines 17 and 18 have been modified and saved. Note that the fill pattern in modification graphic 325 uses diagonal hash lines for fill that are wider than the diagonal hash lines in modification graphic 330. Modification graphic 330 indicates that lines 19 and 20 have both been modified, but not saved. Both modification graphics 325 and 330 are concatenated single line modification graphics. The pattern within the boundaries of the single line modification graphics are designed to create a continuous unified pattern over the multiple lines to give the appearance of a single resulting rectangle shape.

Deletion graphic 335 indicates that a line between lines 25 and 26 has been deleted, but not saved. Modification graphic 340 has fill and indicates the lines 30 and 31 have been modified and saved. The graphics in code listing 300 that indicate that changes have been saved, may have been the result of prior session where changes were made and saved. The graphics indicating changes have been made and not saved may be the result of a current editing session.

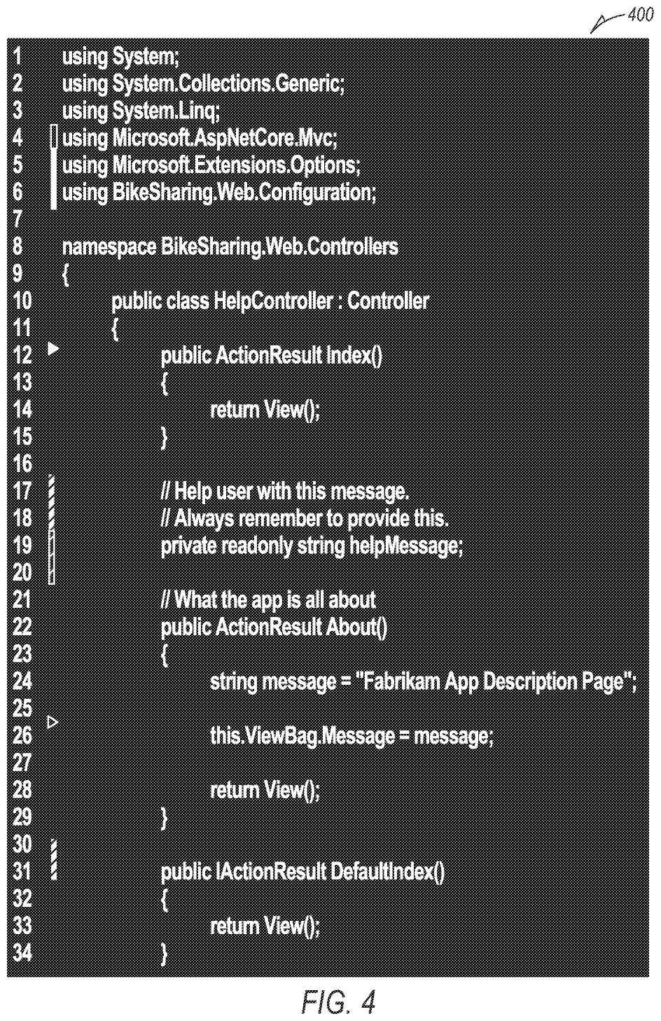

FIG. 4 is a code listing 400 shown in a dark theme utilizing the graphics 200 to identify changes in lines of code. Code listing 400 is identical, and contains the same changes as code listing 300. Reference numbers for the dark theme graphics are omitted due to the dark theme likely obfuscating lead lines.

Example pseudocode corresponding to operations performed by the editor 110 receiving modifications of code by a user is now provided:
Pseudo code:
Receive file open request
Open working copy of the file from source control
Display working copy code listing
Detect cursor moved onto a code line.
Receive changes to the code.
Compare the edited lines in working copy against the previous version in source control.
If the change removed a full code line or lines
   Show a ‘deleted’ change indicator on code listing between the code and the line number
If the change added a full code line or lines
   Show an ‘added’ change indicator on the left between the code and the line number for each added line
If the change modified the code on the line
   Show a modified' change indicator (blue hashed line) on the left between the code and the line number for each added line.
Receive file save command
   Replace all unsaved change indicators turn into their saved state equivalents

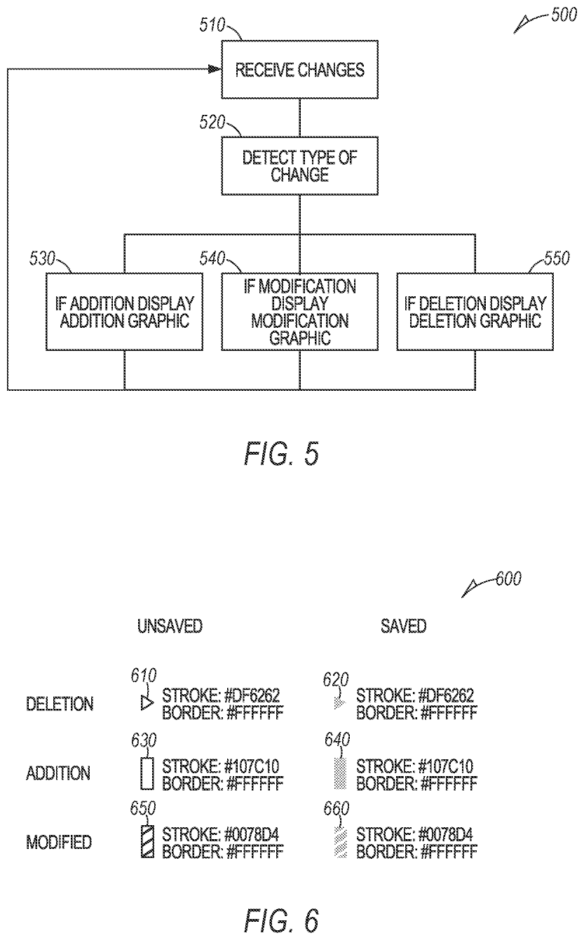

FIG. 5 is a flowchart of a computer implemented method 500 of using different graphic indicators for representing changes to code. Method 500 may be performed by a code editing program such as editor 110 in one example. Method 500 begins at operation 510 by receiving changes to respective lines of code of multiple numbered lines of code displayed by the code editing program. The changes include a deletion type change, an addition type change, and a modification type change. At operation 520, the type of change for each received change is detected. An addition graphic is displayed at operation 530 in response to the type of change being an addition to the line of code. A modification graphic having discernable markings within a boundary of the modification graphic is displayed at operation 540 in response to the type of change being a modification to the line of code. A deletion graphic is displayed at operation 550 in response to the type of change being a deletion of the line of code.

In one example, operation 530 performs mating of adjacent boundaries of their respective graphics in response to multiple contiguous lines of code being modified such that the discernable lines form a continuous uniform pattern over the multiple contiguous lines of modified code.

Method 500 may enlarge a displayed graphic in response to a cursor hovering by the graphic and may also display text describing the type of change.

The addition graphic or modification graphic may be displayed in a margin or gutter after numbers for the lines of code and prior to the beginning of each line of code.

The addition, modification, or deletion graphics comprise shape boundaries with filler in response to the corresponding line of code being saved. The modification graphic filler may include alternating discernable markings that are wider than the modification graphic corresponding to unsaved lines of modified code. In one example, the alternating discernable markings of the modification graphic filler have a different number of alternating discernable markings than the discernable markings within the boundary,

The deletion graphic may be a triangle, while the addition and modification graphics each comprise a same sized rectangle shaped to fit in a margin of the multiple numbered lines of code next to corresponding line numbers.

FIG. 6 is a chart illustrating example graphic indicators generally at 600 having different colors for a blue theme display in addition to the use of a pattern in the modification graphic to help discernably distinguish different types of changes to code. An unsaved deletion graphic 610 is triangular in shape and has a stroke (outline of the border) with a hex color of #DF6262 and a border #FFFFFF. The saved deletion graphic 620 has the same fill color #DF6262 the stroke. Addition graphics 630 and 640 are rectangles with stroke and fill #107C10 and border #FFFFFF. Modification graphics 650 and 660 have strokes and fill of #0078804 and border #FFFFFF. For a dark them version (not shown), the deletion stroke and fill are #FF6666 and the border is #1E1E1E. The addition stroke and fill is #55B155 with a border of #1E1E1e. The modification stroke and fill is #3595DE with a border of #1E1E1E. The colors are designed. to provide additional cues to help easily discern the differences between the graphics and hence more easily identify the type of change for each line of code. Other color schemes may be used in further examples.

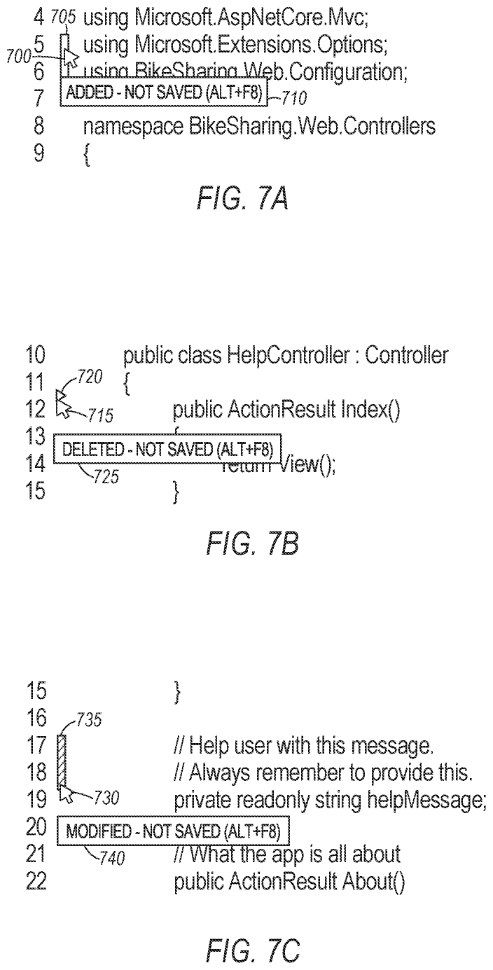

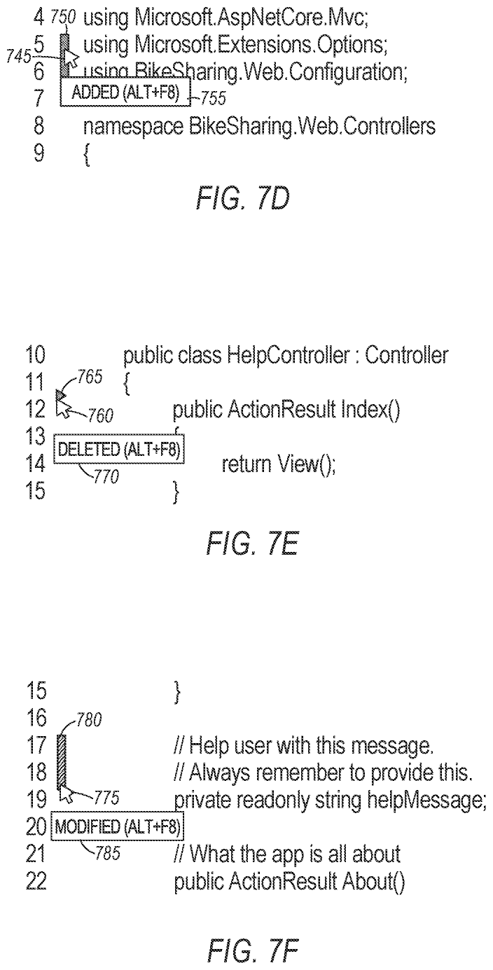

FIGS. 7A, 7B, 7C, 7D, 7E, and 7F are screen shots indicating cursors hovering over or near selected change graphics with a tip shown to indicate the type of change as well as a state of the change corresponding to whether the change has been saved or not saved. In FIG. 7A, a cursor 700 is shown hovering over an addition graphic 705 resulting in a tip 710 indicating the change type is added and the change has not been saved. A keyboard shortcut tip of (Alt-F8) is included in one example to cause display of the actual change that has been made. The actual change is more relevant for a modification to code, as the added code is already visible.

in FIG. 7B, cursor 715 is shown hovering over a deletion graphic 720 resulting in a tip 725 indicating the change type is deleted and the change has not been saved. A keyboard shortcut tip of (Alt-F8) is included in one example to cause display of the actual change that has been made.

In FIG. 7C, cursor 730 is shown hovering over a modification graphic 735 resulting in a tip 740 indicating the change type is modified and the change has not been saved. A keyboard shortcut tip of (Alt-F8) is included in one example to cause display of the actual change that has been made.

In FIG. 7D, a cursor 750 is shown hovering over an addition graphic 755 resulting in a tip 7760 indicating the change type is added and the change has been saved. A keyboard shortcut tip of (Alt-F8) is included in one example to cause display of the actual change that has been made. The actual change is more relevant for a modification to code, as the added code is already visible.

In FIG. 7E, cursor 760 is shown hovering over a deletion graphic 765 resulting in a tip 770 indicating the change type is deleted and the change has been saved. A keyboard shortcut tip of (Alt-F8) is included in one example to cause display of the actual change that has been made.

In FIG. 7F, cursor 775 is shown hovering over a modification graphic 780 resulting in a tip 785 indicating the change type is modified and the change has not been saved. A keyboard shortcut tip of (Alt-F8) is included in one example to cause display of the actual change that has been made.

Each of the change graphics shown in FIGS. 7A-F are enlarged versions of change graphics in response to the corresponding cursors hovering over or near the corresponding change graphics. The number of pixels representing the hovered over graphics may be increased to cause the enlargement. The increase in size should be easily discernable yet not interfere with visibility of the corresponding lines of changed code. The tips may also be placed above or below the corresponding lines if display space is available.

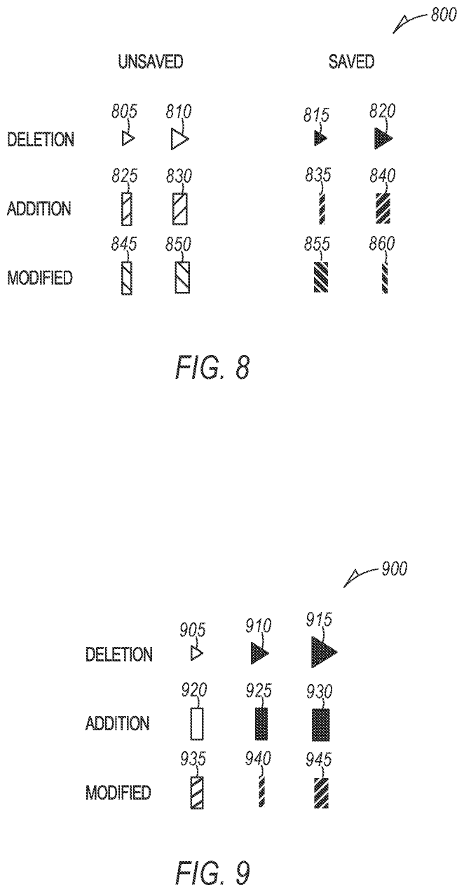

FIG. 8 illustrates alternative change graphics at 800. A deletion graphic 805 is shown as a triangle and corresponds to an unsaved state of the corresponding deleted line of code. In response to a cursor hovering near or on deletion graphic 805, an enlarged deletion graphic 810 is shown. Saved versions with fill are shown at 815 and 820.

An addition graphic 825 has a rectangle shape and is formed with a pattern comprising diagonal lines that ascend from left to right. The number of lines is increased from prior examples and in this example includes six lines. Addition graphic 830 is the cursor hover enlarged version. Both represent an unsaved state. Addition graphics 835 and 840 are the versions with fill representing a saved state. The saved state addition graphics 835 and 840 have the same number of ascending lines that are thicker to discernably represent the saved state.

A modification graphic 845 has a rectangle shape and is formed with a pattern comprising diagonal lines that descend from left to right. The number of lines is increased from prior examples and in this example includes six lines. Modification graphic 850 is the cursor hover enlarged version. Both represent an unsaved state. Addition graphics 855 and 860 are the versions with fill representing a saved state. The saved state addition graphics 855 and 860 have the same number of descending lines that are thicker to discernably represent the saved state.

FIG. 9 illustrates alternative change graphics at 900. A deletion graphic 905 is shown as a triangle and corresponds to an unsaved state of the corresponding deleted line of code. A saved version with fill is shown at 910. In response to a cursor hovering near or on deletion graphic 910, an enlarged deletion graphic 915 is shown.

An addition graphic 920 is shown as a rectangle and corresponds to an unsaved state of the corresponding added line of code. A saved version with fill is shown at 925. in response to a cursor hovering near or on addition graphic 925, an enlarged addition graphic 930 is shown.

A modification graphic 935 has a rectangle shape and is formed. with a pattern comprising diagonal lines that ascend from left to right. The number of lines in this example is three. A saved version with fill is shown at 940, Modification graphic 945 is the cursor hover enlarged version.

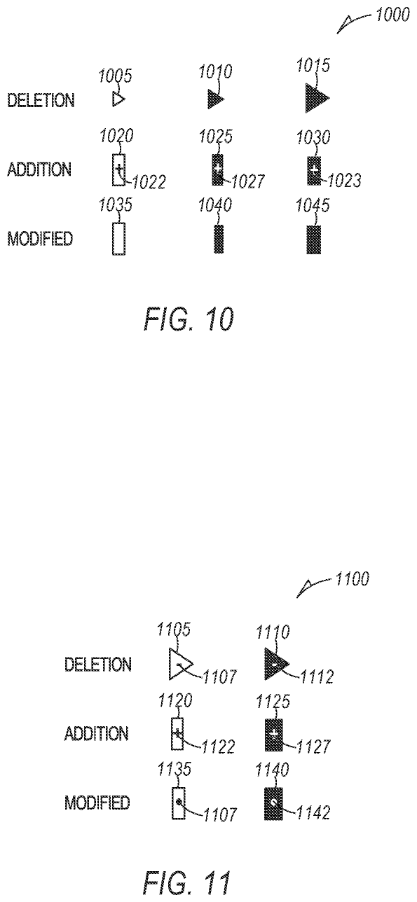

FIG. 10 illustrates alternative modification graphics at 1000. A deletion graphic 1005 is shown as a triangle and corresponds to an unsaved state of the corresponding deleted line of code. A saved version with fill is shown at 1010. In response to a cursor hovering near or on deletion graphic 1010, an enlarged deletion graphic 1015 is shown.

An addition graphic 1020 is shown as a rectangle with a pattern comprising a plus symbol “+” 1022 and corresponds to an unsaved state of the corresponding added line of code. The plus symbol 1022 is centered to enable generation of concatenated addition graphics to for a uniform pattern of uniformly spaced plus symbols 1022. A saved version with fill is shown at 1025 with a plus symbol 1027 shown in the fill. Plus symbol 1027 should have a lighter color, such as white, that visibly contrasts with the darker fill. In response to a cursor hovering near or on addition graphic 1025, an enlarged addition graphic 1030 is shown. In one example, the plus symbol 1032 is the same size as plus symbol 1027 and is not enlarged.

A modification graphic 1035 has a rectangle shape and is formed without a pattern, A saved version with fill is shown at 1040. Modification graphic 1045 is the cursor hover enlarged version.

FIG. 11 illustrates alternative change graphics at 1100. A deletion graphic 1005 is shown as a triangle and corresponds to an unsaved state of the corresponding deleted line of code, A minus symbol “−” 1107 is disposed within the triangle. A saved version with fill is shown at 1010. The saved version also has a minus symbol 1112 and a fill that is dark enough to discernably distinguish from deletion graphic 1105 yet still allow visibility of the minus symbol 1112.

An addition graphic 1120 is shown as a rectangle with a pattern comprising a plus symbol “+” 1122 and corresponds to an unsaved state of the corresponding added line of code, The plus symbol 1122 is centered to enable generation of concatenated addition graphics to for a uniform pattern of uniformly spaced plus symbols 1122. A saved version with fill is shown at 1125 with a plus symbol 1127 shown in the fill.

A modification graphic 1135 has a rectangle shape and is formed with a pattern comprising a dot “.”. A saved version with fill is shown at 1140 with a dot 1142.

The saved versions of the graphics 1100 include an outline illustrating boundaries of the corresponding shapes. The unsaved version may have a light shading or color, with the saved versions having a discernible outline to help contrast the differences between saved in unsaved. The use of the minus symbol for deletions of lines of code is symbolic of subtraction or deletion. The use of a plus symbol for is also symbolic of addition or adding lines of code. The use of the dot is simply easily distinguishable from the plus and minus symbols, which by default implies the remaining modified type of change.

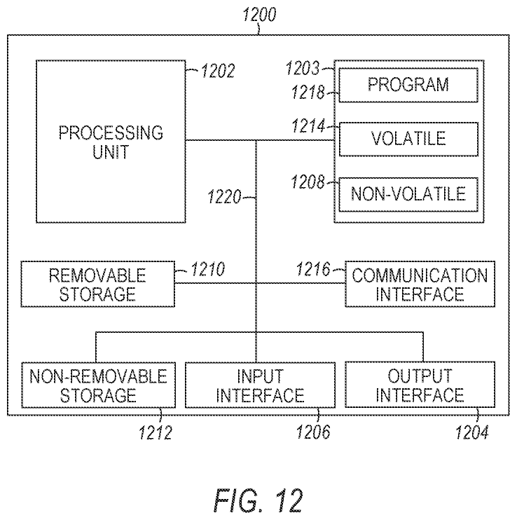

FIG. 12 is a block schematic diagram of a computer system 1200 to generate multiple different types of change graphics to indicate changes in code listings and for performing methods and algorithms according to example embodiments. All components need not be used in various embodiments.

One example computing device in the form of a computer 1200 may include a processing unit 1202, memory 1203, removable storage 1210, and non-removable storage 1212. Although the example computing device is illustrated and described as computer 1200, the computing device may be in different forms in different embodiments. For example, the computing device may instead be a smartphone, a tablet, smartwatch, smart storage device (SSD), or other computing device including the same or similar elements as illustrated and described with regard to FIG. 12. Devices, such as smart-phones, tablets, and smartwatches, are generally collectively referred to as mobile devices or user equipment.

Although the various data storage elements are illustrated as part of the computer 1200, the storage may also or alternatively include cloud-based storage accessible via a network, such as the Internet or server-based storage. Note also that an SSD may include a processor on which the parser may be run, allowing transfer of parsed, filtered data through I/O channels between the SSD and main memory.

Memory 1203 may include volatile memory 1214 and non-volatile, memory 1208. Computer 1200 may include — or have access to a computing environment that includes a variety of computer-readable media, such as volatile memory 1214 and non-volatile memory 120$, removable storage 1210 and non-removable storage 1212. Computer storage includes random access memory (RAM), read only memory (ROM), erasable programmable read-only memory (EPROM) or electrically erasable programmable read-only memory (EEPROM), flash memory or other memory technologies, compact disc. read-only memory (CD ROM), Digital Versatile Disks (DVD) or other optical disk storage, magnetic cassettes, magnetic tape, magnetic disk storage or other magnetic storage devices, or any other medium capable of storing computer-readable instructions.

Computer 1200 may include or have access to a computing environment that includes input interface 1206, output interface 1204, and a communication interface 1216. Output interface 1204 may include a display device, such as a touchscreen, that also may serve as an input device. The input interface 1206 may include one or more of a touchscreen, touchpad, mouse, keyboard, camera, one or more device-specific buttons, one or more sensors integrated within or coupled via wired or wireless data connections to the computer 1200, and other input devices. The computer may operate in a networked environment using a communication connection to connect to one or more remote computers, such as database servers. The remote computer may include a personal computer (PC), server, router, network PC, a peer device or other common data flow network switch, or the like. The communication connection may include a Local Area Network (LAN), a Wide Area Network (WAN), cellular, Wi-Fi, Bluetooth, or other networks. According to one embodiment, the various components of computer 1200 are connected with a system bus 1220.

Computer-readable instructions stored on a computer-readable medium are executable by the processing unit 1202 of the computer 1200, such as a program 1218. The program 1218 in some embodiments comprises software to implement one or more methods described herein. A hard drive, CD-ROM, and RAM are some examples of articles including a non-transitory computer-readable medium such as a storage device. The terms computer-readable medium, machine readable medium, and storage device do not include carrier waves or signals to the extent carrier waves and signals are deemed too transitory. Storage can also include networked storage, such as a storage area network (SAN). Computer program 1218 along with the workspace manager 1222 may be used to cause processing unit 1202 to perform one or more methods or algorithms described herein.

### EXAMPLES

1. A computer implemented method includes receiving changes to respective lines of code of multiple numbered lines of code displayed by a code editing program, the changes including a deletion type change, an addition type change, and a modification type change, and for each change. The type of change is detected for each received change. Display of an addition graphic is caused in response to the type of change being an addition to the line of code. Display of a modification graphic having discernable markings within a boundary of the modification graphic is caused in response to the type of change being a modification to the line of code. Display of a deletion graphic is caused in response to the type of change being a deletion of the line of code.

2. The method of example 1 wherein the discernable markings include discernable lines.

3. The method of example 2 wherein the discernable lines include a diagonal hash within the modification graphic.

4. The method of any of examples 2-3 wherein the addition and modification graphics include rectangular shapes.

5. The method of example 4 and further including mating adjacent boundaries of graphics in response to multiple contiguous lines of code being modified such that the discernable lines form a continuous uniform pattern over the multiple contiguous lines of modified code.

6. The method of any of examples 1-5 and further including enlarging a graphic in response to a cursor hovering by the graphic and displaying text describing the type of change.

7. The method of any of examples 1-6 wherein the addition graphic or modification graphic is displayed in a margin with numbers for the lines of code prior to the beginning of each line of code.

8. The method of example 7 wherein the addition graphic and modification graphic are taller than they are wider.

9. The method of any of examples 1-8 wherein the addition, modification, or deletion graphics include shape boundaries with filler in response to the corresponding line of code being saved.

10. The method of example 9 wherein the modification graphic filler includes alternating discernable markings that are wider than the modification graphic corresponding to unsaved lines of modified code.

11. The method of example 10 wherein the alternating discernable markings of the modification graphic filler have a different number of alternating discernable markings than the discernable markings within the shape boundary.

12. The method of any of examples 1-11 wherein the deletion graphic is a triangle and the addition and modification graphics each comprise a same sized rectangle shaped to fit in a margin of the multiple numbered lines of code next to corresponding line numbers.

13. The method of any of examples 1-12 wherein the discernable markings include a pattern.

14. A machine-readable storage device having instructions for execution by a processor of a machine to cause the processor to perform operations to perform any of the methods of example 1-13.

15. A device includes a processor and a memory device coupled to the processor and having a program stored thereon for execution by the processor t to perform operations to perform any of the methods of example 1-13.

Although a few embodiments have been described in detail above, other modifications are possible. For example, the logic flows depicted in the figures do not require the particular order shown, or sequential order, to achieve desirable results. Other steps may be provided, or steps may be eliminated, from the described flows, and other components may be added to, or removed from, the described systems. Other embodiments may be within the scope of the following claims.

1. A computer implemented method comprising:
receiving changes to respective lines of code of multiple numbered lines of code displayed by a code editing program, the changes including a deletion type change, an addition type change, and a modification type change, and for each change:
detecting the type of change for each received change;
causing display of an addition graphic in response to the type of change being an addition to the line of code;
causing display of a modification graphic having discernable markings within a boundary of the modification graphic in response to the type of change being a modification to the line of code; and
causing display of a deletion graphic in response to the type of change being a deletion of the line of code.

2. The method of claim 1 wherein the discernable markings comprise discernable lines.

3. The method of claim 2 wherein the discernable liners comprise a diagonal hash within the modification graphic.

4. The method of claim 2 wherein the addition and modification graphics comprise rectangular shapes.

5. The method of claim 4 and further comprising mating adjacent boundaries of graphics in response to multiple contiguous lines of code being modified such that the discernable lines form a continuous uniform pattern over the multiple contiguous lines of modified code.

6. The method of claim 1 and further comprising enlarging a graphic in response to a cursor hovering by the graphic and displaying text describing the type of change.

7. The method of claim 1 wherein the addition graphic or modification graphic is displayed in a margin with numbers for the lines of code prior to the beginning of each line of code.

8. The method of claim 7 wherein the addition graphic and modification graphic are taller than they are wider.

9. The method of claim 1 wherein the addition, modification, or deletion graphics comprise shape boundaries with filler in response to the corresponding line of code being saved.

10. The method of claim 9 wherein the modification graphic filler comprises alternating discernable markings that are wider than the modification graphic corresponding to unsaved lines of modified code.

11. The method of claim 10 wherein the alternating discernable markings of the modification graphic filler have a different number of alternating discernable markings than the discernable markings within the shape boundary.

12. The method of claim 1 wherein the deletion graphic is a triangle and the addition and modification graphics each comprise a same sized rectangle shaped to fit in a margin of the multiple numbered lines of code next to corresponding line numbers.

13. The method of claim 1 wherein the discernable markings comprise a pattern.

14. A machine-readable storage device having instructions for execution by a processor of a machine to cause the processor to perform operations to perform a method, the operations comprising:
receiving changes to respective lines of code of multiple numbered lines of code displayed by a code editing program, the changes including a deletion type change, an addition type change, and a modification type change, and for each change:
detecting the type of change for each received change;
causing display of an addition graphic in response to the type of change being an addition to the line of code;
causing display of a modification graphic having discernable markings within a boundary of the modification graphic in response to the type of change being a modification to the line of code; and
causing display of a deletion graphic in response to the type of change being a deletion of the line of code.

15. The device of claim 14 wherein the discernable markings comprise discernable lines.

16. The device of claim 15 wherein the discernable lines comprise a diagonal hash within the modification graphic.

17. The device of claim 15 wherein the addition and modification graphics comprise rectangular shapes, the operations further comprising mating adjacent boundaries of graphics in response to multiple contiguous lines of code being modified such that the discernable lines form a continuous uniform pattern over the multiple contiguous lines of modified code.

18. The device of claim 14 wherein the operations further comprise enlarging a graphic in response to a cursor hovering by the graphic and displaying text describing the type of change and wherein the addition graphic or modification graphic is displayed in a margin with numbers for the lines of code prior to the beginning of each line of code.

19. The device of claim 14 wherein the deletion graphic is a triangle, wherein the addition and modification graphics each comprise a same sized rectangle shaped to fit in a margin of the multiple numbered lines of code next to corresponding line numbers, and wherein the discernable markings comprise a pattern.

20. A device comprising:
a processor; and
a memory device coupled to the processor and having a program stored thereon for execution by the processor to perform operations comprising:
receiving changes to respective lines of code of multiple numbered lines of code displayed by a code editing program, the changes including a deletion type change, an addition type change, and a modification type change, and for each change:
detecting the type of change for each received change;
causing display of an addition graphic in response to the type of change being an addition to the line of code;
causing display of a modification graphic having discernable markings within a boundary of the modification graphic in response to the type of change being a modification to the line of code; and
causing display of a deletion graphic in response to the type of change being a deletion of the line of code.
